(19) United States
(12) Patent Application Publication
(10) Pub. No.: US 2011/0061701 A1
(43) Pub. Date: Mar. 17, 2011

(54) BED COVER WITH AN ATTACHABLE TENT

(75) Inventor: Hugo Washington Perez, Ramsey, NJ (US)

(73) Assignee: Franco Manufacturing Company, Inc., Metuchen, NJ (US)

(21) Appl. No.: 12/876,331

(22) Filed: Sep. 7, 2010

Related U.S. Application Data
(60) Provisional application No. 61/241,626, filed on Sep. 11, 2009.

(51) Int. Cl. E04H 15/02; E04H 15/54; E04H 15/58; B23P 11/00

(52) U.S. Cl. 135/96; 135/115; 29/428

(57) ABSTRACT

A bed tent for use in connection with an article of bedding is disclosed herein. In accordance with one embodiment, a bed tent comprises a panel, an article of bedding, and at least an attachment means for attaching at least a portion of the panel to an article of bedding.

### CROSS-REFERENCE TO RELATED APPLICATIONS

This application claims priority to, and the benefit of, pending U.S. Provisional Application Ser. No. 61/241,626, filed Sep. 11, 2009, entitled “Bed Cover with an Attachable Tent,” the disclosure of which is incorporated herein by reference in its entirety.

### BACKGROUND

1. Field of the Invention

Embodiments of the present invention generally relate to a bed cover with an attachable tent. More specifically, embodiments of the present invention relate to a relatively easily assembled, collapsible tent for use in connection with a bed cover or other such bedding or sleeping article.

2. Description of the Related Art

Living in societies and environments completely run by adults has a tendency to alienate children, leaving them feeling stateless, having no territory to call their own. In efforts to give children a place to call home and be creative and imaginative, various manufacturers and companies have developed forts and tents that allow children and adults alike to stake out at least a small piece of land for their own fantasy world, be it on the living room floor, in the backyard, or otherwise. However, all of these structures require adult assistance, such as in the areas of assembly and setup; even if a child attempts to assemble a structure, adult supervision would be required to ensure the safety and protection of the child from sharp edges, potential suffocation hazards, and other obstacles.

Children's forts of various types and styles are currently made by several manufacturers. Known designs include tents that are assembled by attaching material together using suction cups and ropes in order to erect the fort. However, such structures are complicated, sometimes dangerous, and typically require adult supervision during assembly.

Other known designs include a tent that can be placed on top of a bed. Such structures may pop up and stay up using a wire and material construction. These products are difficult to assemble and disassemble to and from the fully erect position of the tent. Additionally, the wire edges are not comfortable for the child's body to be in contact with and can cause serious discomfort and possibly injury.

Thus, there is a need for a bed cover with a relatively simple, detachably attachable tent that is safe during assembly and in operation, and capable of assembly by a child with minimal or no assistance from an adult.

### SUMMARY

Embodiments of the present invention generally relate to a bed cover with a detachably attachable tent. More specifically, embodiments of the present invention relate to a collapsible tent for use in connection with a bed cover or other such article.

In accordance with one embodiment of the present invention, a bed tent is provided comprising at least a first panel comprising a child-safe support material, and at least an attachment means for attaching at least a portion of the first panel to an article of bedding.

In accordance with another embodiment of the present invention, a bed tent is provided comprising at least a first panel, an article of bedding, and at least an attachment means for attaching at least a portion of the first panel to an article of bedding.

In accordance with another embodiment of the present invention, a bed tent is provided comprising a panel having a substantially planar surface, a front side, a back side, a top edge, a bottom edge, side edges, and a foldable means centered on a plane perpendicular to the planar surface located between the top edge and the bottom edge dividing the panel into a plurality of panel sections; wherein the panel is foldable about the foldable means so the back side of each of the plurality of panel sections is movable inwardly toward the foldable means, wherein the panel forms a canopy substantially enclosing an area below the canopy above an article of bedding covering a bed; a child-safe support material for providing child-safe support to the panel, wherein the child-safe support material may be secured within a void formed between the front side and the back side of the panel; and an attachment means secured to the panel for detachably attaching at least a portion of the panel to the article of bedding.

In accordance with yet another embodiment of the present invention, a bed tent is provided comprising at least a first panel and a second panel; an article of bedding; and at least an attachment means for attaching at least a portion of at least one of the at least first and second panels to at least a portion of the article of bedding.

In accordance with yet another embodiment of the present invention, a bed tent is provided comprising a plurality of panels, each having a substantially planar surface, a front side, a back side, a proximate edge, a distal edge, and side edges; a panel attachment secured to the proximate edge of each of the plurality of panels for detachably attaching the proximate edges of each of the plurality of panels together forming a canopy substantially enclosing an area below the canopy above an article of bedding covering a bed; a child-safe support material for providing child-safe support to each of the plurality of panels, wherein the child-safe support material may be secured within a void formed between the front side and the back side of each panel; a bedding attachment secured to a distal edge of each of the plurality of panels for detachably attaching the distal edge of each of the plurality of panels to an article of bedding covering the bed.

In accordance with yet another embodiment of the present invention, a bed tent is provided comprising a top panel having a front side and a back side, a proximate edge, a distal edge, a first side edge and a second side edge; a front panel having a front side and a back side (not shown), a proximate edge, a distal edge, a first side edge, a second side edge, and a first bed attachment secured to the front panel distal edge for detachably attaching the tent to an article of bedding covering a bed, wherein the front panel proximate edge may be secured to the top panel proximate edge with a foldable top panel attachment; a first side panel having a front side and a back side, a proximate edge, a distal edge, an inner side edge, an outer side edge, and a second bed attachment secured to the first side panel distal edge for detachably attaching the tent to the article of bedding, wherein the inner side edge of the first side panel may be secured to the first side edge of the front panel with a first foldable tent attachment and the first side panel proximate edge may be detachably attached to the first side edge of the top panel; a second side panel having a front side and a back side, a proximate edge, a distal edge, an inner side edge, an outer side edge, and a third bed attachment secured to the second side panel distal edge for detachably attaching the tent to the article of bedding, wherein the inner side edge of the second side panel may be secured to the second side edge of the front panel with a second foldable tent attachment and the second side panel proximate edge may be detachably attached to the second side edge of the top panel; and a child-safe support material for providing child-safe support to the tent, wherein the child-safe support material may be secured within a void formed between the front side and the back side of the top panel, the front side and the back side of the front panel, the front side and the back side of the first side panel, and the front side and the back side of the second side panel; wherein the back side of the first side panel, the back side of the second side panel, and the back side of the top panel may be folded inwardly toward the back side of the front panel forming a canopy substantially enclosing an area below the canopy above an article of bedding covering a bed.

In accordance with yet another embodiment of the present invention, a bed tent assembly is provided comprising an article of bedding for covering a bed having a top side and a bottom side wherein the bottom side of the article of bedding overlays a top surface of a bed; and a tent attachment secured to the top of the article of bedding for removably attaching the article of bedding to a tent; and a bed tent comprising a plurality of panels, each having a substantially planar surface, a front side, a back side, a proximate edge, a distal edge, and side edges; a panel attachment secured to the proximate edge of each of the plurality of panels for detachably attaching the proximate edges of each of the plurality of panels together forming a canopy substantially enclosing an area below the canopy above an article of bedding covering a bed; a child-safe support material for providing child-safe support to each of the plurality of panels, wherein the child-safe support material may be secured within a void formed between the front side and the back side of each panel; a bedding attachment secured to a distal edge of each of the plurality of panels for detachably attaching the distal edge of each of the plurality of panels to the tent attachment.

In accordance with yet another embodiment of the present invention, a method of manufacturing a bed tent is provided comprising providing a length of a textile; cutting a panel from the length of a textile; providing child-safe support material; cutting a strip of the child-safe support material; installing the strip of the child-safe support material in the panel; and securing a bedding attachment means to the panel for attachment to a piece of bedding material; providing the piece of bedding material; and securing a tent attachment means to the piece of bedding material for attachment to the bedding attachment means, comprises providing at least a length of a material, cutting a first panel from the length of a material, providing an amount of a stiffener material, cutting a plurality of elongated strips of a stiffener material spanning substantially the length of the first panel's shortest span, installing the plurality of elongated strips of stiffener material in the first panel, installing at least an attachment means on at least a portion of the first panel, and repeating the method for additional panels, if needed.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments encompassed within the scope of the present invention, and, therefore, are not to be considered limiting, for the present invention may admit to other equally effective embodiments, wherein:

FIG. 1 depicts a top view of an unfolded bed tent in accordance with an embodiment of the present invention;

FIG. 2 depicts a perspective view of the bed tent from FIG. 1 in a folded position;

FIG. 3 depicts a top view of an unassembled bed tent panel in accordance with another embodiment of the present invention;

FIG. 4 depicts a perspective view of a bed tent showing the bed tent panel from FIG. 3 in a folded position; and

FIG. 5 depicts a top view of an unfolded bed tent in accordance with another embodiment of the present invention;

FIG. 6 depicts a perspective view of a bed tent assembly in a folded position, showing a bed tent similar to that depicted in FIG. 5, attached to an article of bedding, covering a bed in accordance with one embodiment of the present invention; and

FIG. 7 is a flow chart depicting a method in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

FIG. 1 depicts a top view of an unfolded bed tent 100 in accordance with embodiments of the present invention. The bed tent 100 may generally comprise a panel 101 having a substantially planar surface, a front side, a back side (not shown), a top edge 102, a bottom edge 103, side edges 104, and a foldable means 106 centered on a plane perpendicular to the planar surface located between the top edge 102 and the bottom edge 103, dividing the panel into a plurality of panel sections 110. In accordance with embodiments of the present invention, the panel 101 is foldable about the foldable means 106 so the back side of each of the plurality of panel sections 110 is movable inwardly toward the foldable means 106 wherein the panel 101 forms a canopy substantially enclosing an area below the canopy above an article of bedding covering a bed. In accordance with embodiments of the present invention, the bed tent 100 may also comprise child-safe support material 112 for providing child-safe support to the panel, wherein the child-safe support material may be secured within a void formed between the front side and the back side of the panel and panel material 114. In accordance with embodiments of the present invention, the tent 100 may also comprise an attachment means 116 secured to the panel 101 for detachably attaching at least a portion of the panel 101 to an article of bedding.

In accordance with embodiments of the present invention, the panel 101 may generally comprise a panel material 114 comprising any material feasible in embodiments of the present invention, including but not limited to any material or textile material (such as cloth, linen, silk, cotton, Nylon®, Nylon® blends, polymers, polymer blends, etc.) or any combination thereof. In addition, although depicted in FIG. 1 as a generally rectangular shape, it should be noted the panel 101, as well as any other panels utilized in connection with embodiments of the present invention, may take any shape feasible in embodiments of the present invention, including but not limited to polygonal, circular, ovoid, and freeform shapes, without departing from the scope of embodiments of the present invention. Further, in accordance with embodiments of the present invention, the panel 101 may comprise a substantially planar surface, or any other surface in accordance with embodiments of the present invention. In alternative embodiments of the present invention, the panel 101 may comprise any surface shape and texture feasible in embodiments of the present invention including but not limited to, concave, convex, smooth, curved, and contoured surfaces, and the like, for example. Although top edge 102, the bottom edge 103, and the side edges 104 are depicted as straight lines in FIG. 1, the edges 102, 103, and 104 may form any shape, length, or thickness in accordance with embodiments of the present invention, including, for example, cartoon characters, cars, animals, other child-friendly shapes, and the like. The shape may generally be child-friendly and easily assembled by children.

In accordance with embodiments of the present invention, the foldable means 106 may generally comprise any textile or structure capable of folding, such as a seam or a hinge, and the like. The plurality of panel sections 110 may generally comprise any textile material and may comprise any size and shape feasible within embodiments of the present invention. In accordance with embodiments of the present invention, the foldable means 106 may separate the panel 101 into a plurality of panel sections 110 of equivalent size. In alternative embodiments of the present disclosure, the foldable means 106 may separate the panel 101 into a plurality of panel sections of unequal size.

The bed tent may also comprise one or more lengths of a child-safe support material 112, depicted in FIG. 1 as high-density foam strip inserts (hereinafter “stiffeners”). These stiffeners 112 may comprise any material or combination of materials feasible in embodiments of the present invention, for example, to provide rib-like structure or stiffness or rigidity sufficient for the structure to be erected in some manner such that it creates at least an area for receiving a child and/or adult. The material or combination of materials of the stiffeners 112 include but are not limited to any open- or closed-cell foam material that is compressible and presents an insubstantial or negligible risk to a child. The stiffeners 112 may also comprise a material that is compressible, child-safe, and elastic or semi-elastic in nature, such as viscoelastic polyurethane foam (e.g., “memory foam”). In another embodiment, the stiffeners 112 may constitute polymer tubing, which may be encased or otherwise disposed in the material of a panel.

In accordance with alternative embodiments of the present invention, the stiffeners 112 may be installed into at least the panel 101 to form a rigid or semi-rigid structure, capable of maintaining itself in a formed position when stationary and not subjected to extraneous external forces. As depicted, the stiffeners 112 may be installed into the panel 101 by way of disposing them into a plurality of identifiable pockets formed in a void in the panel, or by placing the stiffeners 112 within the panel and sewing or sealing the material area around the stiffener 112, thus holding the stiffener 112 in a substantially fixed position. The sewing or sealing operation may be conducted utilizing any conventional technique, including hand-sewing, machine-sewing, heat-sealing (as with a polymeric or thermoplastic fabric), any other technique feasible in embodiments of the present invention, or any combination thereof.

In accordance with another embodiment of the present invention, the stiffeners 112 in the bed tent may be removably replaceable. In such an embodiment, any number of stiffeners 112 may be placed into voids, pockets or crevasses in the panels, as described herein, and be able to be removed at any time. The stiffeners may then be replaced after a period of time, when, for example, the stiffeners 112 begin to lose rigidity or so the panel material 114 may be washed or laundered when it becomes soiled.

Although depicted in FIG. 1 as containing four stiffeners 112, it should be noted that embodiments of the present invention may contain any number of stiffeners feasible in embodiments of the present invention without departing from the scope of embodiments of the present invention. For example, in accordance with one embodiment, the panel may contain two stiffeners, one at either end, which may be sufficient to bestow the aforementioned characteristics on the panel. Additionally, although shown as parallel to the short end of a rectangular shape, the stiffeners may be configured in any fashion feasible in embodiments of the present invention without departing from the scope of embodiments of the present invention. By way of example, the stiffeners may be configured to form an “X” or honeycomb configurations.

Furthermore, although depicted as rectangular in shape, the stiffeners 112 may take any shape feasible in embodiments of the present invention without departing from the scope of embodiments of the present invention. In accordance with one embodiment of the present invention, stiffeners 112 may take any form, including flat, rounded, hollow, cylindrical, polygonal, circular, spheroid, or other shapes.

In accordance with one embodiment, the shape of the stiffeners 112 may be dictated or otherwise influenced by the shape of the panel 101. For example, circular or semicircular panels may utilize rounded or curved stiffeners located at least one point for purposes of ease of manufacturing and ease of installation. In an embodiment utilizing substantially flat or planar panels and substantially flat or planar stiffeners, the structure of the tent may allow for rolling and compression of the bed tent, thus minimizing the volume and/or surface area of the bed tent and facilitating efficient storage.

Additionally, although depicted as rib-like members, it should be noted the stiffeners can take any form feasible in embodiments of the present invention. For example, the stiffeners may constitute at least a portion or substantially all of the area and/or volume inside any one or more of the panels. In such a manner, the stiffener(s) may include a single rigid or semi-rigid member encased in the material of a panel.

Also as depicted in FIG. 1, at the panel 101 may be fitted with at least an attachment means 116. The attachment means 116 may comprise any attachment means feasible in embodiments of the present invention, including but not limited to hook-and-loop fasteners (e.g., Velcro®), one or more adhesive strips, buckles, buttons, clasps, clips, flanges, frogs, pegs, pins, rings, snaps, straps, ties, zippers, any other attachment means, and combinations thereof. Although depicted in FIG. 1 as having two strips of Velcro®-like material it should be noted any number of any combination of attachment means may be utilized in connection with embodiments of the present invention without departing from the scope of embodiments of the present invention.

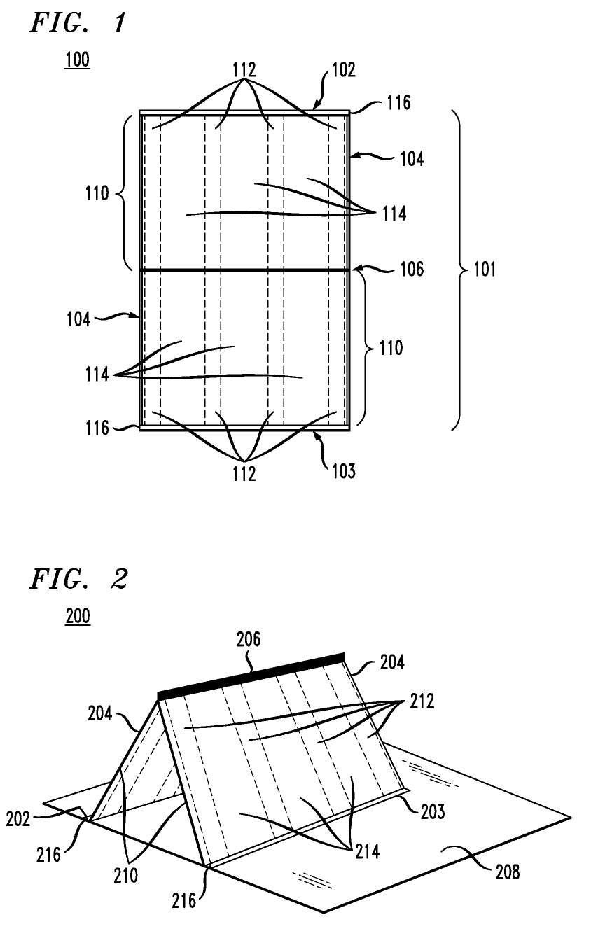

FIG. 2 depicts a perspective view of a bed tent 200 from FIG. 1 in a folded or assembled position in accordance with one embodiment of the present invention. A plurality of panel sections 210 may have identical, substantially similar, or substantially different features and characteristics in various embodiments of the present invention. In accordance with many embodiments of the present invention, a top edge 202, bottom edge 203, side edges 204, foldable means 206, child-safe support material 212, the panel material 214, and the attachment means 216, are similar to those described in FIG. 1.

In embodiments of the present invention, the plurality of panel sections 210 may be attached in a manner such that the panels and the surface upon which each panel rests 208 form a generally triangular shape. This may be accomplished by attaching at least a portion of each of the plurality of panel sections 210 in contact to form a foldable means 206 generally comprising an apex or joint surface. In such a manner, a child may play in, or use for recreation, the triangular space formed by the plurality of panel sections 210 and the surface upon which the panels rest 208 (e.g., bed cover, floor, etc.) as his/her own territory.

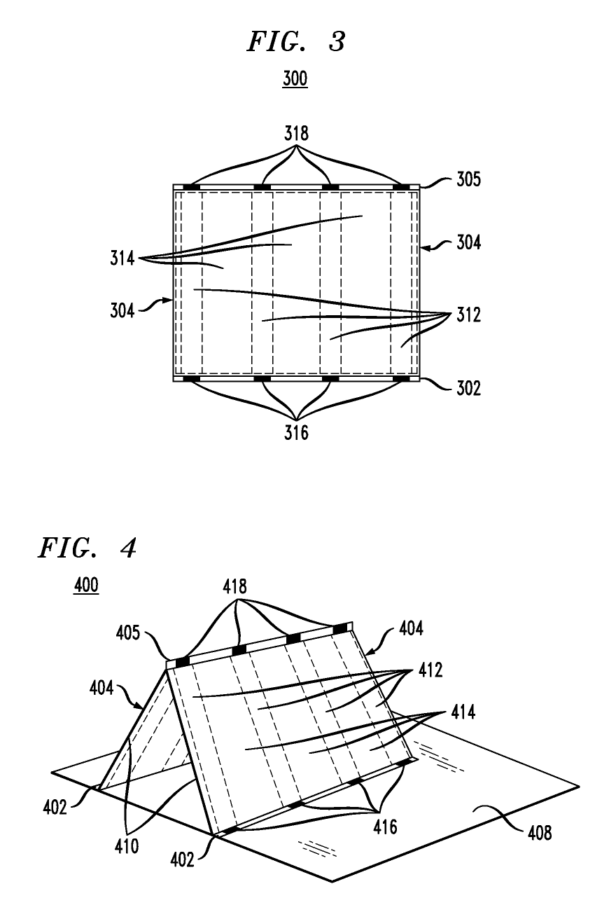

In one embodiment, at least a portion of each of the plurality of panel sections 210 may be removably attached at the apex or joint surface by way of attachment means, as shown in FIGS. 3 and 4 and described herein with respect to previously-described embodiments of the present invention. In embodiments of the present invention, the patterns, design, texture, indicia, theme, and the like on the plurality of panel sections 210 is similar or identical. By way of example, a car theme may be chosen in which the plurality of panel sections 210 form the structure of the top portion of a car and the surface upon which the panels rest 208 comprises a bed cover with a design depicting a bottom portion of the car. In embodiments of the present invention, the tent 200 generally may comprise the same patterns and indicia as the surface upon which the panels rest 208. These coordinated patterns and themes are within the scope of embodiments of the present invention.

The attachment means 216 nearest the surface 208 upon which the panels rest may serve to attach one or more of the panels to the surface 208. For example, the attachment means 216 disposed on each of the plurality of panel sections 210 may comprise a hook strip (i.e., one section of a hook-and-loop fastener system), while the surface 208, such as a comforter, article of bedding, floor, or other surface feasible in embodiments of the present invention, may contain a loop strip (i.e., the other section of the hook-and-loop fastener system); when engaged, the hook strip and the loop strip would produce a fastening mechanism, which requires some force to disengage.

As discussed earlier with respect to other previously-described embodiments of the present invention, any number of panels 210 may be connected or otherwise engaged without departing from the scope of embodiments of the present invention. The space formed by the panels 210 and the surface 208 or surfaces involved may be generally triangular, rectangular, otherwise polygonal, circular, freeform shaped or any other shape feasible in embodiments of the present invention.

In accordance with one embodiment, a panel may be utilized in connection with, for example, a bed cover and a wall, creating a sort of “lean-to” structure. In such an embodiment, the first panel may be attached to no surface or to one or both surfaces, creating a generally right-triangular shaped space in which a child may play. If in the configuration of a “lean-to,” the panel may be attached on one end to the bed and on the distal edge to a wall or other structure (not shown).

In accordance with one embodiment of the present invention, the bed tent 210 may be collapsed in a relatively simplistic manner. In such an embodiment, one or more panels may be joined at an edge and/or via foldable means 206 as described hereinabove. To collapse, if a plurality of panels 210 is joined at an foldable means 206, the panels 210 may be folded along the foldable means 206 to collapse into a relatively flat structure with relatively low volume; if the plurality of panels is connected by no other means than by attachment means, the plurality of panels 210 may be stacked on top of each other and stored. This process may be easily completed by small children and thus would not necessarily require adult supervision.

FIG. 3 depicts a top view of an unassembled bed tent panel section 300 in accordance with embodiments of the present invention. The panel section 300 may have identical, substantially similar, or substantially different features and characteristics in various embodiments of the present invention. In addition, the panel section 300 may comprise a panel having a substantially planar surface, a front side, a back side (not shown), a proximate edge 305, a distal edge 302, and side edges 304. In accordance with many embodiments of the present invention, the panel section 300 may also comprise a panel attachment 318 secured to the proximate edge 305 of each of a plurality of panels for detachably attaching the proximate edges 308 of each of a plurality of panels together forming a canopy substantially enclosing an area below the canopy above an article of bedding covering a bed. Additionally, in accordance with embodiments of the present invention, the panel section 300 may further comprise a child-safe support material 312 for providing child-safe support to each panel 300, wherein the child-safe support material 312 may be secured within a void formed between the front side and the back side of the panel. Further, in accordance with embodiments of the present invention, the panel section 300 may also comprise a bedding attachment 316 secured to a distal edge 302 of the panel section 300 for detachably attaching the distal edge 302 of the panel section to an article of bedding covering the bed. Further, in accordance with embodiments of the present invention, the panel section 300, may also comprise a panel attachment 318 secured to proximate edge 305 of the panel section 300 for detachably attaching the proximate edge 305 of the panel section to one or more additional panel sections (see FIG. 4). In accordance with many embodiments of the present invention, the side edges 304, child-safe support material 312, a panel material 314, and the attachment means 316, are similar to those depicted and described above in FIGS. 1 and 2.

In alternative embodiments of the present invention, the proximate edge 305 and the distal edge 302 may be of any length, shape, size feasible in embodiments of the present invention. In addition, in accordance with embodiments of the present invention, the panel attachment 318 may comprise any attachment means feasible in embodiments of the present invention, including but not limited to hook-and-loop fasteners (e.g., Velcro®), one or more adhesive strips, buckles, buttons, clasps, clips, flanges, frogs, pegs, pins, rings, snaps, straps, ties, zippers, any other attachment means, and combinations thereof. Any number of any combinations of attachment means may be utilized in connection with embodiments of the present invention without departing from the scope of embodiments of the present invention. In accordance with embodiments of the present invention, the panel section 300 may comprise any size and shape and any material feasible in embodiments of the present invention. In accordance with embodiments of the present invention, the panel section 300 may be foldable, and alternatively, the panel section 300 may not be foldable. Generally, one or more panel sections 300 may be assembled to form any bed tent feasible in embodiments of the present invention.

FIG. 4 depicts a perspective side view of a bed tent including a plurality of panels 410 similar to the bed tent panel described in FIG. 3. In embodiments of the present invention, a plurality of panels 410 may be attached to each other in a manner such that the panels and the surface upon which each panel rests 408 form a canopy substantially enclosing an area below the canopy above a surface 408. This may be accomplished by attaching at least a portion of each panel section 410 to a portion of another panel section. In such a manner, a child may play in, or use for recreation, the space formed by the panel sections 410 and the surface upon which the panels rest 408 (e.g., bed cover, floor, etc.) as his/her own territory. In one embodiment, at least a portion of each of the panel section 410 may be removably attached at the apex or joint surface by way of a panel attachment 418 with respect to previously-described embodiments of the present invention. In accordance with many embodiments of the present invention, a proximate edge 405, a distal edge 402, a side edges 404, the surface upon which each panel rests 408, a child-safe support material 412, a panel material 414, a bedding attachment 416, and a panel attachment 418, are similar to those described in FIGS. 2 and 3.

The attachment means 416 nearest the surface upon which the panels rest 408 may serve to attach one or more of the panels 410 to the surface 408. For example, the attachment means 416 disposed on each of the panel sections 410 may comprise a hook strip (i.e., one section of a hook-and-loop fastener system), while the surface 408, such as a comforter, article of bedding, floor, or other surface feasible in embodiments of the present invention, may contain a loop strip (i.e., the other section of the hook-and-loop fastener system); when engaged, the hook strip and the loop strip would produce a fastening mechanism which requires some force to disengage.

As discussed earlier with respect to other previously-described embodiments of the present invention, any number of panels 410 may be connected or otherwise engaged without departing from the scope of embodiments of the present invention. The space formed by the panels 410 and the surface 408 or surfaces involved may be generally triangular, rectangular, otherwise polygonal, circular, freeform shaped or any other shape feasible in embodiments of the present invention.

In accordance with one embodiment of the present invention, the bed tent 400 may be disassembled in a relatively simplistic manner. In such an embodiment, one or more panels 410 may be joined at an edge and/or a panel attachment 418 as described hereinabove. To disassemble, the panel attachment 418 may be disengaged from an engaged position. If plurality of panels 410 is connected by no other means than by the panel attachment 418, the plurality of panels 410 may be stacked on top of each other and stored. This process may be easily completed by small children and thus would not necessarily require adult supervision.

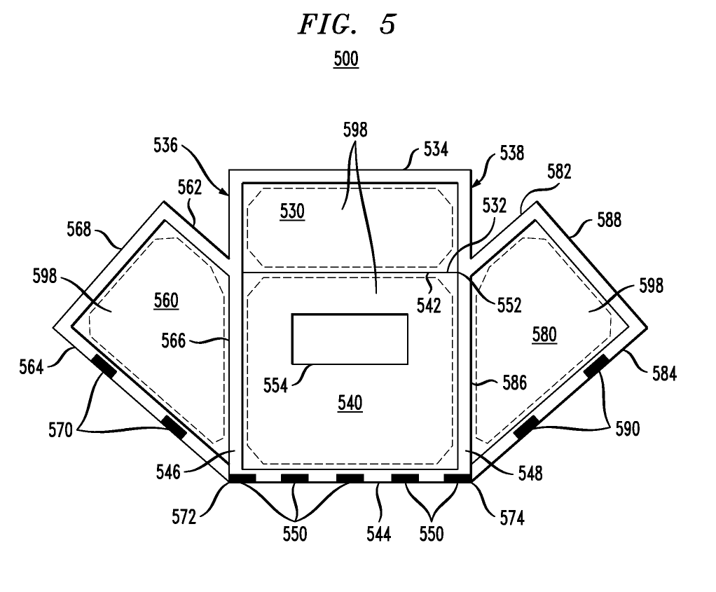

FIG. 5 depicts a top view of an unfolded bed tent 500 in accordance with alternative embodiments of the present invention. In accordance with alternative embodiments of the present invention, the bed tent 500 comprises a top panel 530 having a front side and a back side (not shown), a top panel proximate edge 532, a top panel distal edge 534, a first side edge 536 and a second side edge 538; a front panel 540 having a front side and a back side (not shown), a front panel proximate edge 542, a front panel distal edge 544, a first side edge 546, a second side edge 548, and a first bed attachment 550 secured to the front panel distal edge 544 for detachably attaching the tent 500 to an article of bedding covering a bed, wherein the front panel proximate edge 542 may be secured to the top panel proximate edge 532 with a foldable top panel attachment 552; a first side panel 560 having a front side and a back side (not shown), a first side panel proximate edge 562, a first side panel distal edge 564, an inner side edge 566, an outer side edge 568, and a second bed attachment 570 secured to the first side panel distal edge 564 for detachably attaching the tent 500 to the article of bedding, wherein the inner side edge 566 of the first side panel 560 may be secured to the first side edge 546 of the front panel 540 with a first foldable tent attachment 572 and the first side panel proximate edge 562 may be detachably attached to the first side edge 536 of the top panel 530; a second side panel 580 having a front side and a back side (not shown), a second side panel proximate edge 582, a second side panel distal edge 584, an inner side edge 586, an outer side edge 588, and a third bed attachment 590 secured to the second side panel distal edge 584 for detachably attaching the tent 500 to the article of bedding, wherein the inner side edge 586 of the second side panel 580 may be secured to the second side edge 548 of the front panel 540 with a second foldable tent attachment 574 and the second side panel proximate edge 582 may be detachably attached to the second side edge 538 of the top panel 530; and a child-safe support material 598 for providing child-safe support to the tent 500, wherein the child-safe support material 598 may be secured within in a void formed between the front side and the back side of the top panel 530, the front side and the back side of the front panel 540, the front side and the back side of the first side panel 560, and the front side and the back side of the second side panel 580, wherein the back side of the first side panel 560, the back side of the second side panel 580, and the back side of the top panel 530 may be folded inwardly toward the back side of the front panel 540 forming a canopy substantially enclosing an area below the canopy above an article of bedding covering a bed, wherein the enclosed area is large enough for acceptance of a child. In accordance with alternative embodiments of the present disclosure, the tent 500 may further comprise a window 554 cut out of the front panel 540 or any other panel.

In accordance with embodiments of the present invention, while the top panel 530, the front panel 540, the first side panel 560, and the second side panel 580 are depicted with various shapes, any size and shape is contemplated within the embodiments of the present invention. In accordance with embodiments of the present invention, the top panel 530, the front panel 540, the first side panel 560, and the second side panel 580, and the child-safe support material 598 may comprise any child-safe material. For example, soft compressible materials and textiles may be use to prevent the risk of injury to a child. The child-safe support materials to be used in accordance with the embodiments depicted in FIG. 5 are similar to those described in FIGS. 1, 2, 3, and 4. In accordance with many embodiments of the present invention. The edges 532, 534, 536, 538, 542, 544, 546, 548, 562, 5264, 566, 568, 582, 584, 586, and 588 may comprise any angle, size, shape, texture, and the like feasible in accordance with embodiments of the present invention.

In accordance with alternative embodiments of the present invention, the window 554 may comprise any size and shape feasible in accordance with embodiments of the present invention. For example, the window 554 may comprise a car window shape, a spaceship window shape, a ship porthole shape, or a double window shape. Additionally, for example, any number of windows 554 cut out of any panel 530, 540, 560, and 580 is contemplated within the embodiments of the present invention. In accordance with embodiments of the present invention, the attachments 552, 572, and 574, and any other attachment in accordance with embodiments depicted in FIG. 5 are similar to those described in other embodiments depicted in FIGS. 1, 2, 3, and 4.

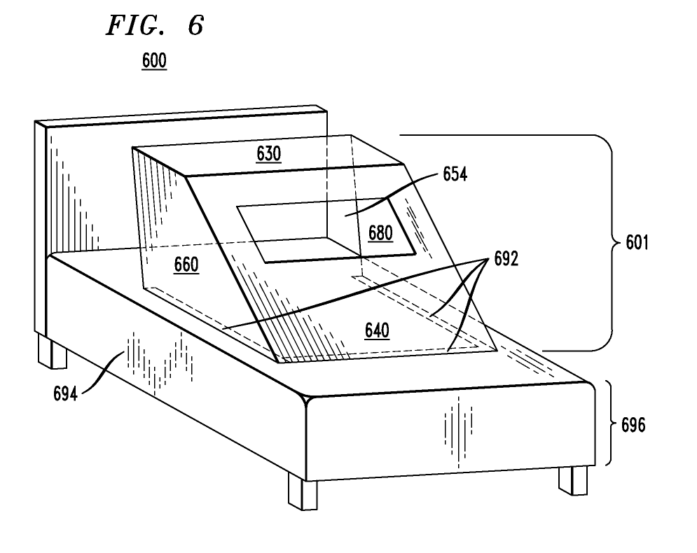

FIG. 6 depicts a perspective side view of a bed tent assembly 600 comprising a bed tent 601 similar to that depicted in FIG. 5 in a folded position attached to an article of bedding 694 covering a bed 696 in accordance with one embodiment of the present invention. In accordance with embodiments of the present invention, the article of bedding 694 may comprise a top side and a bottom side (not shown), wherein the bottom side of the article of bedding may overlay the top surface of the bed 696. In alternative embodiments of the present invention, the article of bedding 694 may also comprise a tent attachment secured to the top of the article of bedding 694 for removably attaching the article of bedding 694 to the tent 601. A top panel 630, a front panel 640, a first side panel 660, a second side panel 680, and a window 654 may have identical, substantially similar, or substantially different features and characteristics in various embodiments of the present invention, including those depicted and described in FIG. 5.

In accordance with many embodiments of the present invention, the front panel 640, the first side panel 660, and the second side panel 680 may comprise a plurality bedding attachments 692 detachably attachable to a correspondent attachment secured to the article of bedding 694. In embodiments of the present invention, the plurality of bedding attachments 692 may have similar properties to those described in embodiments of the present invention depicted and described in FIGS. 1-4, as well as all alternative attachment means with similar properties. For example, the plurality bedding attachments 692 may comprise a hook strip (i.e., one section of a hook-and-loop fastener system), while the article of bedding 694 or other surface feasible in embodiments of the present invention, may contain a loop strip (i.e., the other section of the hook-and-loop fastener system); when engaged, the hook strip and the loop strip would produce a fastening mechanism, which requires some force to disengage.

As discussed earlier with respect to other previously-described embodiments of the present invention, any number of panels may be connected or otherwise engaged without departing from the scope of embodiments of the present invention. The space formed by the panels and the surface or surfaces involved may be generally triangular, rectangular, otherwise polygonal, circular, freeform shaped, or any other shape and size feasible in embodiments of the present invention.

In accordance with one embodiment of the present invention, the bed tent 601 may be collapsed or disassembled in a relatively simplistic manner. In such an embodiment, one or more panels may be joined at an edge and/or via attachment means as described hereinabove. To collapse, if a plurality of panels is joined at a foldable means, the panels may be folded along the foldable means to collapse into a relatively flat structure with relatively low volume.

In accordance with an alternative embodiment of the present invention, if the plurality of panels is connected by a disengagable attachment means, the disengagable attachment mans may be disengaged and the plurality of panels may be stacked on top of each other and stored, such that a child may easily disassemble and assemble the tent 601. Any combination of foldable means and disengagable attachment means are contemplated in the embodiments of the present invention.

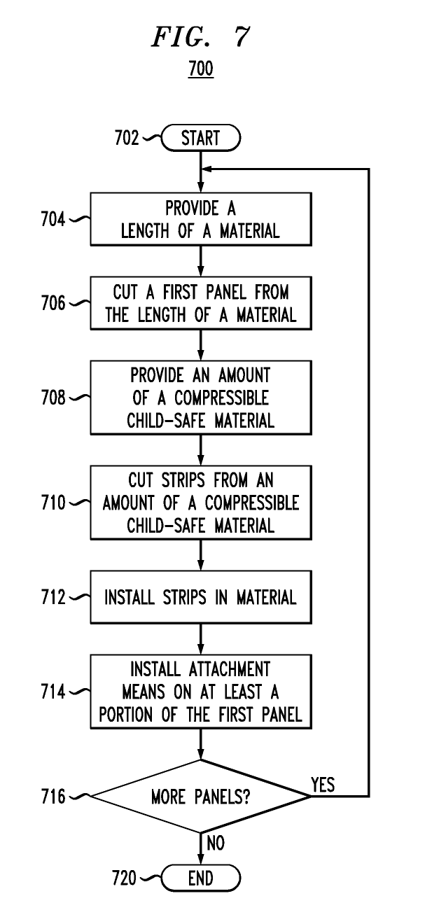

Referring now to FIG. 7, a method 700 of manufacturing a children's bed tent is depicted in flowchart form in accordance with yet another embodiment of the present invention. The method 700 may begin at block 702. After block 702, the method 700 may then proceed to step 704.

In step 704, a length of material is provided. The material may be any material described hereinabove with respect to the material utilized in previously-described embodiments of the present invention, including but not limited cloth, linen, silk, cotton, Nylon®, Nylon® blends, polymers, polymer blends, etc. and other textile materials. After step 704, the method 700 may proceed to step 706.

In step 706, a first panel is cut from the length of a material. The first panel may take any shape feasible in embodiments of the present invention, including those described hereinabove, such as polygonal, circular, and freeform shape. In accordance with embodiments of the present invention, the first panel may be cut by hand, machine, mechanical device, or any other feasible means for cutting a panel from a length of material. After step 706, the method 700 may proceed to step 708.

In step 708, an amount of a child-safe support material is provided. This material may comprise any material or combination of materials feasible in embodiments of the present invention, including but not limited to any open- or closed-cell foam material that is compressible and presents an insubstantial or negligible risk to a child. The material may also comprise a material that is compressible, child-safe, and elastic or semi-elastic in nature, such as viscoelastic polyurethane foam (e.g., “memory foam”). In another embodiment, the stiffeners may constitute polymer tubing, which may be encased or otherwise disposed in the material of a panel. After step 708, the method 700 may proceed to step 710.

In step 710, strips of the child-safe support material may be cut. Any number of flat, semi-flat, curved, round, oval or any other shaped strips may be cut in accordance with embodiments of the present invention, and the strips may take on any shape described hereinabove with respect to previously-described embodiments of the present invention, or any combination thereof. After step 710, the method 700 may proceed to step 712.

In step 712, the strips of the child-safe support material may be installed in the first panel. This may be accomplished by way of disposing them into a plurality of pockets formed in the first panel, or by placing the strips within the first panel and sewing or sealing the material area around the strip, thus holding the strip in a substantially fixed position. The sewing or sealing operation may be conducted utilizing any conventional technique, including hand-sewing, machine-sewing, heat-sealing (as with a polymeric or thermoplastic fabric), any other technique feasible in embodiments of the present invention, or any combination thereof. In accordance with another embodiment of the present invention, the stiffeners in the bed tent may be removably replaceable. In such an embodiment, any number of stiffeners may be placed into pockets or crevasses in the panels, as described herein, and be able to be removed at any time. The stiffeners may then be replaced after a period of time, when, for example, the stiffeners begin to lose rigidity or the panel material 114 may be washed or laundered when soiled. After step 712, the method 700 may proceed to step 714.

In step 714, the first panel may be fitted with at least a bedding attachment means. The bedding attachment means may comprise any attachment means feasible in embodiments of the present invention, including but not limited to hook-and-loop fasteners (e.g., Velcro®), one or more adhesive strips, buckles, buttons, clasps, clips, flanges, frogs, pegs, pins, rings, snaps, straps, ties, zippers, any other attachment means, and combinations thereof. Any number of any combinations of bedding attachment means may be utilized in connection with embodiments of the present invention without departing from the scope of embodiments of the present invention. After step 714, the method 700 may proceed to decision 716.

In decision 716, the manufacturer decides if more than one panel needs to be manufactured. If any subsequent panels are to be manufactured, the method 700 may proceed to step 704 and repeat each subsequent step as described hereinabove. If only a first panel will be manufactured, the method 700 may proceed to termination block 718. The method 700 terminates at termination block 718.

In alternative embodiments of the present invention, prior to proceeding to the termination block 718, the method 700 may proceed to providing a piece of bedding material and securing a tent attachment means to the piece of bedding material for attachment to the bedding attachment means in a manner feasible with embodiments of the present invention or similar formatives thereof.

While the foregoing is directed to embodiments of the present invention, other and further embodiments of the invention may be devised without departing from the basic scope thereof. In particular, it should be appreciated that any element of any embodiments disclosed herein may be combined with any other elements from any other embodiments disclosed herein, in accordance with yet further embodiments of the present invention.

What is claimed is:

1. A bed tent comprising:
a panel having a substantially planar surface, a front side, a back side, a top edge, a bottom edge, side edges, and foldable means centered on a plane perpendicular to the planar surface located between the top edge and the bottom edge, dividing the panel into a plurality of panel sections;
wherein the panel is foldable about the foldable means so the back side of each of the plurality of panel sections is movable inwardly toward the foldable means wherein the panel forms a canopy substantially enclosing an area below the canopy above an article of bedding covering a bed;
child-safe support material for providing child-safe support to the panel, wherein the child-safe support material is secured within a void formed between the front side and the back side of the panel; and
an attachment means secured to the panel for detachably attaching at least a portion of the panel to the article of bedding.

2. The bed tent of claim 1, wherein the void is substantially the same size as the panel.

3. The bed tent of claim 2, wherein the child-safe support material is substantially the same size as the void.

4. The bed tent of claim 1, wherein the child-safe support material comprises viscoelastic polyurethane foam.

5. The bed tent of claim 1, wherein the attachment means comprises a hook and loop fastener.

6. The bed tent of claim 1, wherein the attachment means is secured to at least one of the top edge of the panel and the bottom edge of the panel.

7. The bed tent of claim 1, wherein the article of bedding coordinates with the panel.

8. The bed tent of claim 1, wherein the void comprises a pocket having a pocket opening.

9. The bed tent of claim 8, wherein the child-safe support material is removably replaceable from the panel through the pocket opening.

10. A bed tent comprising:
a plurality of panels, each having a substantially planar surface, a front side, a back side, a proximate edge, a distal edge, and side edges;
a panel attachment secured to the proximate edge of each of the plurality of panels for detachably attaching the proximate edges of each of the plurality of panels together forming a canopy substantially enclosing an area below the canopy above an article of bedding covering a bed;
a child-safe support material for providing child-safe support to each of the plurality of panels, wherein the child-safe support material is secured within a void formed between the front side and the back side of each panel;
a bedding attachment secured to a distal edge of each of the plurality of panels for detachably attaching the distal edge of each of the plurality of panels to an article of bedding covering the bed.

11. The bed tent of claim 10, wherein the panel attachment comprises hook and loop fasteners.

12. The bed tent of claim 10, wherein the bedding attachment comprises hook and loop fasteners.

13. The bed tent of claim 10, wherein each of the plurality of panels is substantially the same size and each void is substantially the same size as each panel.

14. The bed tent of claim 13, wherein the child-safe support material is substantially the same size as each void.

15. The bed tent of claim 10, wherein the child-safe support material comprises viscoelastic polyurethane foam.

16. The bed tent of claim 10, wherein each void comprises a pocket having a pocket opening.

17. The bed tent of claim 16, wherein the child-safe support material is removably replaceable from each of the plurality of panels through the pocket opening.

18. A bed tent comprising:
a top panel having a front side and a back side, a proximate edge, a distal edge, a first side edge and a second side edge;
a front panel having a front side and a back side, a proximate edge, a distal edge, a first side edge, a second side edge, and a first bed attachment secured to the front panel distal edge for detachably attaching the tent to an article of bedding covering a bed, wherein the front panel proximate edge is secured to the top panel proximate edge with a foldable top panel attachment;
a first side panel having a front side and a back side, a proximate edge, a distal edge an inner side edge, an outer side edge, and a second bed attachment secured to the first side panel distal edge for detachably attaching the tent to the article of bedding, wherein the inner side edge of the first side panel is secured to the first side edge of the front panel with a first foldable tent attachment and the first side panel proximate edge may be detachably attached to the first side edge of the top panel;
a second side panel having a front side and a back side, a proximate edge, a distal edge an inner side edge, an outer side edge, and a third bed attachment secured to the second side panel distal edge for detachably attaching the tent to the article of bedding, wherein the inner side edge of the second side panel may be secured to the second side edge of the front panel with a second foldable tent attachment and the second side panel proximate edge may be detachably attached to the second side edge of the top panel; and
a child-safe support material for providing child-safe support to the tent, wherein the child-safe support material is secured within in a void formed between the front side and the back side of the top panel, the front side and the back side of the front panel, the front side and the back side of the first side panel, and the front side and the back side of the second side panel;
wherein the back side of the first side panel, the back side of the second side panel, and the back side of the top panel may be folded inwardly toward the back side of the front panel forming a canopy substantially enclosing an area below the canopy above an article of bedding covering a bed.

19. The bed tent of claim 18, wherein each of the proximate edges is attached with a hook and loop fastener.

20. The bed tent of claim 18, wherein each void is substantially the same size as each panel.

21. The bed tent of claim 20, wherein each child-safe support material is substantially the same size as each void.

22. The bed tent of claim 18, wherein the child-safe support material comprises viscoelastic polyurethane foam.

23. The bed tent of claim 18, wherein the first foldable tent attachment and the second foldable tent attachment are zippers and the first side panel and the second side panel are removable from the front panel when the zippers are unzipped.

24. The bed tent of claim 18, wherein the front panel further comprises a window cut out of a portion of the front panel.

25. The bed tent of claim 18, wherein each void comprises a pocket having a pocket opening.

26. The bed tent of claim 25, wherein the child-safe support material is removably replaceable from each of the plurality of panels through the pocket opening.

27. A bed tent assembly comprising:
an article of bedding for covering a bed having a top side and a bottom side wherein the bottom side of the article of bedding overlays a top surface of a bed; and
a tent attachment secured to the top of the article of bedding for removably attaching the article of bedding to a tent; and
a bed tent comprising:
a plurality of panels, each having a substantially planar surface, a front side, a back side, a proximate edge, a distal edge, and side edges;
a panel attachment secured to the proximate edge of each of the plurality of panels for detachably attaching the proximate edges of each of the plurality of panels together forming a canopy substantially enclosing an area below the canopy above an article of bedding covering a bed;
a child-safe support material for providing child-safe support to each of the plurality of panels, wherein the child-safe support material is secured within a void formed between the front side and the back side of each panel;
a bedding attachment secured to a distal edge of each of the plurality of panels for detachably attaching the distal edge of each of the plurality of panels to the tent attachment.

28. The bed tent assembly of claim 27, wherein the top side of the article of bedding and the front side of each of the plurality of panels comprise the same indicia.

29. The bed tent assembly of claim 27, wherein each of the proximate edges is attached with a hook and loop fastener.

30. The bed tent assembly of claim 27, wherein each of the plurality of panels comprises a predetermined shape and size and each void is substantially the same size and shape as each panel.

31. The bed tent assembly of claim 27, wherein the child-safe support material is substantially the same size as each void.

32. The bed tent assembly of claim 27, wherein the child-safe support material comprises viscoelastic polyurethane foam.

33. The bed tent assembly of claim 27, wherein each void comprises a pocket having a pocket opening.

34. The bed tent assembly of claim 33, wherein the child-safe support material is removably replaceable from each of the plurality of panels through the pocket opening

35. A method for manufacturing a bed tent, comprising:
providing a length of canopy material;
cutting a panel from the length of the canopy material;
providing child-safe support material;
cutting a strip of the child-safe support material;
installing the strip of the child-safe support material in the panel; and
securing a bedding attachment means to the panel for attachment to a piece of bedding material.

36. The method of claim 35, further comprising:
providing the piece of bedding material;
securing a tent attachment means to the piece of bedding material for attachment to the bedding attachment means.

37. The method of claim 35, wherein the child-safe support material comprises viscoelastic polyurethane foam.

38. The method of claim 35 wherein the strip of the child-safe support material is installed by disposing the strip into a void formed in the first panel.

39. The method of claim 35, wherein the attachment means is a hook and loop fastener.
